(19) United States
(12) Patent Application Publication
(10) Pub. No.: US 2003/0020739 A1
(43) Pub. Date: Jan. 30, 2003

(54) System and method for comparing populations of entities

(76) Inventors: Jeremy Stein Cohen, Sunnyvale, CA (US); Ashok Narain Srivastava, Mountain View, CA (US); Ying Zhao, Cupertino, CA (US)

Correspondence Address: HOWREY SIMON ARNOLD & WHITE, LLP, BOX 34, 301 RAVENSWOOD AVE., MENLO PARK, CA, 94025, US

(21) Appl. No.: 09/917,409

(22) Filed: Jul. 26, 2001

(51) Int. Cl. G09G 5/00

(52) U.S. Cl. 345/700

(57) ABSTRACT

The present invention provides management of entity profile data to effectively process, analyze, and review entity profile data. More specifically, the present invention provides a unified data analysis and processing scheme to break down and review entity profile data. The present invention also provides an interactive visualization tool for the strategists and web site-maintainers to effectively and efficiently review entity profile data. This tool provides strategists and site-maintainers an easy method of managing web-sites and optimizing web-site design for customers of interest.

### FIELD OF THE INVENTION

The present invention relates to the field of web-site management, visualization, business methods, manufacturing, process, quality control, information technology, customer relationship management, external customer relationship management, electronic customer relationship management, information processing, customer analysis and methods. Specifically, the present invention involves software programs and visualization tools for processing, analyzing, and visualizing profile data regarding arbitrary entities in a variety of formats on a computer and other processing devices.

### BACKGROUND OF THE INVENTION

I. The Web

The Internet is a global network of computers and computer networks (“the Net”). The Internet connects computers that use a variety of different operating systems or languages, including UNIX, DOS, Windows, Macintosh, and others. With the increasing size and complexity of the Internet, tools have been developed to find information on the network, often called navigators or navigation systems. Examples of such navigation systems include Archie, Gopher, and WATS. The more recently developed World Wide Web (“WWW” or “the Web”) is one such navigation system that also serves as an information distribution and management system for the Internet.

The Web uses hypertext and hypermedia. Hypermedia is any media that allows users to transit between and within various types and sources of media. Hypertext is a subset of hypermedia and refers to a system that utilizes computer-based “pages” in which readers move within a page or from one page to another page in a non-linear manner by using hyperlinks. Hyperlinks are links embedded within a Web-page that allow Web-site visitors to navigate to other Web-pages. The Web uses a client-server architecture to implement hypertext. The computers that maintain Web information are called Web-servers. A Web-server is a software program on a Web host computer that answers requests from Web-clients, typically over the Internet. The Web-servers enable a Web-site visitor to access hypertext and hypermedia pages from Web file servers. A Web-client is a software program on a computer that requests data from Web-servers. The Web-clients enable a Web-site visitor to access the Web-server. The Web, then, can be viewed as a collection of pages (residing on Web host computers) that are interconnected by hyperlinks using networking protocols, forming a virtual “Web” that spans the Internet.

A Web page viewed by a Web-site user, or visitor, (via the Web-site visitor's computer monitor or other display device) may present simple text only or may appear as a complex document, integrating, for example, text, images, sounds, and/or animation. Each such page may also contain hyperlinks to other Web pages, such that a Web-site visitor at the client computer using a mouse may click on an icon or other item to activate a hyperlink to jump to a new page on the same or a different Web-server.

A Web-server can log activity information regarding a user's Web-client requests for information via a Web-client. For each such client request, a Web-server can record the Internet address of the client, the time of the request, the page requested, the information requested or other information. The Web-server may also record other data as the operator of the Web-server sees fit.

II. Data Classification

Classification is an artificial intelligence technique used to determine data types for each member of a set of inputted data. In a typical classification scheme an artificial intelligence source is trained or otherwise programmed to classify different data into separate classes. These separate classes may be manually specified by the user. After the computer is provided with a method to delineate classes, it can classify each piece of data into a specific class.

Clustering is another artificial intelligence technique, and is based on grouping data that is similar in a set of attributes. A cluster of entities is a group of entities whose data entries are in some way similar. Clustering may be performed on data to group the data into clusters based on a formula to minimize the data distance between members of a cluster. The clusters may also be created by any of several clustering algorithms well known in the art, such as the K-means algorithm.

Several patents disclose the classification and clustering of data into specific clusters. Some of these patents will be discussed below.

U.S. Pat. No. 6,014,904 discloses a method of automatically classifying multi-parameter data. The patent is focused on classifying samples from flow cytometry experiments into separate clusters. Among other differences, this patent relies on the numerical characteristic values of the various particles to classify the data.

U.S. Pat. No. 6,122,628 discloses a method of multidimensional data clustering for indexing and searching. Among other differences, this patent is directed to reducing the dimensionality of data without taking into account relationships between the data.

U.S. Pat. No. 6,236,985 discloses a method for searching databases and finding peer groups in the data. Among other differences, this patent is directed to e-commerce applications but is not directed to provide data regarding profile characteristics of clusters.

Each of the above-described patents fails to disclose an ability to quickly represent and interactively visualize entity profiles to an analyst. Instead, these and other patents disclose methods that rely on cumbersome searches by analysts to determine the nature of the clusters in entity profile data.

III. Visualization

Visualization tools are typically implemented to allow users to view large or complex data sets in concise graphical representations. These tools may be computer-generated graphics drawn to represent data. They also may be organized windows containing data. The graphical representation of the data is meant to allow a user to understand and manipulate the data more easily and more quickly than through a similar review of raw data. Visualization provides a user with the ability to quickly read and view various data sets and other information. Typically, visualization is implemented through a graphical user interface (GUI). The GUI provides the ability to interactively select and focus in on data of interest, allowing the GUI-user to display the data he or she finds most relevant in the manner best suited for the data.

IV. Profiling of Entities

An entity is any item that may be at least partially describable by data.

The problem of comparing two or more populations of entities is wide-spread in industry. Standard statistical methods in use in industry include analysis of variance and multi-variate analysis of variance. The goal of profiling entities is to understand the important characteristics that differentiate two or more populations.

Customer profiling is a technique used in many areas and industries.

These industries include retail, telecommunications, and electronic media, for example. For instance, U.S. Pat. No. 6,125,173 describes a customer-profile based messaging system that tailors messages to customers based on the customers' attributes. As another example, U.S. Pat. No. 5,754,939 discloses use of a profiler mechanism to identify articles deemed to most closely match the user's interests and to present such articles for the user.

Though customer profiling is prevalent in our society, its power has yet to be fully harnessed to enhance web-sites, internet sales, manufacturing systems, process systems, trial systems, biomedical systems, information technology systems, and telecommunications systems. Further, current profiling applications fail to provide information to the user or analyst in readily accessible formats. The user or analyst may need to read through several large and detailed tables to glean desired information regarding customer profiles and segmentation.

### OBJECTS AND SUMMARY OF THE PRESENT INVENTION

The present invention is designed to analyze customer profile data in a series of steps. The present invention is also designed to provide a simple, fast, and efficient method for users or analysts to determine the nature of a cluster of entities. According to the present invention, entity profile data is first collected by a computer system or analyst. Second, the entity profile is analyzed. Finally, the entity profile data is displayed. The present invention differs from the prior art in a number of ways, including that the invention can be applied to non-scientific data, for example. The present invention also differs from the prior art in the use of a novel Graphical User Interface to display entity profile data, for example.

The present invention is also designed to enhance electronic media and web-site design. The present invention allows an analyst to view the profiles of users of electronic media. By viewing their profiles the analyst may be able to adjust the electronic media to present information tailored to the users of the electronic media.

The present invention also contains a software visualization tool for a user to view and analyze profile data. The software uploads entity profile data from a storage system. Then the software calculates statistics for the entity profile data and presents the statistics to the user of the software. The software also enables the user to adjust the parameters of the statistics he is viewing in order to focus on the statistics most relevant to his or her needs.

### BRIEF DESCRIPTION OF THE DRAWINGS

The present invention may be better understood with reference to the detailed description in conjunction with the following figures where like numerals denote identical elements, and in which:

FIG. 1 depicts an exemplary window of profile data.

FIG. 2 depicts an exemplary table of profile data

FIG. 3 depicts a second exemplary window of profile data.

FIG. 4 depicts a third exemplary window of profile data.

FIG. 5 depicts a fourth exemplary window of profile data.

FIG. 6 depicts a fifth exemplary window of profile data.

FIG. 7 depicts a sixth exemplary window of profile data.

FIG. 8 depicts a seventh exemplary window of profile data.

FIG. 9 depicts a list of possible exemplary categories to be used with the Segment Analyzer.

FIG. 10 shows a program storage device having a storage area for storing a machine-readable program of instructions that are executable by the machine for performing the method of the present invention of analyzing and visualizing profile data.

Definitions

Baseline Segment: A Segment against which the Focal Segment is being compared. The Baseline Segment may possess unique character attributes.

Baseline Segment Members: Entities within the data that contain attributes within the parameters for the Baseline Segment.

Boolean Field: A data entry that can only contain a true/false or 0/1 entry.

Category: A way of viewing data. For instance “by revenue”, “by demographic characteristic”, or “by month”. A category may be a data attribute.

Characteristic: A characteristic is any specific identifier of a piece of data. For instance, “Male,” “high income,” or “Married”.

Entity: Any item that may be at least partially describable by data. For example, an entity may be an individual person, drug trial subject, a mechanical or electrical device, a car or plant.

Field/Field Descriptor: A particular data attribute or characteristic that may be analyzed. For instance, “gender” or “income level”.

Field Member: A Field Member is an entity that has a “true” or “1” entry corresponding to a particular Field.

Field Value: A value or data entry of the Field Descriptor of an entity.

Focal Segment: The Segment that is being analyzed by the user.

Numeric Field: A data entry which may be an Integer or a Real Number

Profile Data: A collection of Field Members that at least partially defines a subset of a population of entities.

Segment: A population or sub-population of entities. For example, “Men that live in the Northwest”, “Red machines manufactured in Hungary,” or “Oral pain medications with low dosage requirements.”

Segment Category: A Segment Category is synonymous with a Field. It is a category of a Segment. The Segment Category may be a Category or Field present in a currently selected Segment.

User: A person utilizing the system and method for comparing entities.

### DETAILED DESCRIPTION OF THE VARIOUS EMBODIMENTS

The present invention of displaying and analyzing profile data may be embodied as a software application resident with, in or on any number of computers and may be implemented with a single- or multiple-window visualizer. The present invention may display and analyze customer profile data generated by web-sites recording visits to retail or wholesale web-sites. In one embodiment of the present invention, the visualizer may be created with four modules. These modules may be a Parameter Selector, a Profiler Dashboard, a Segment Visualizer, and a Segment Analyzer.

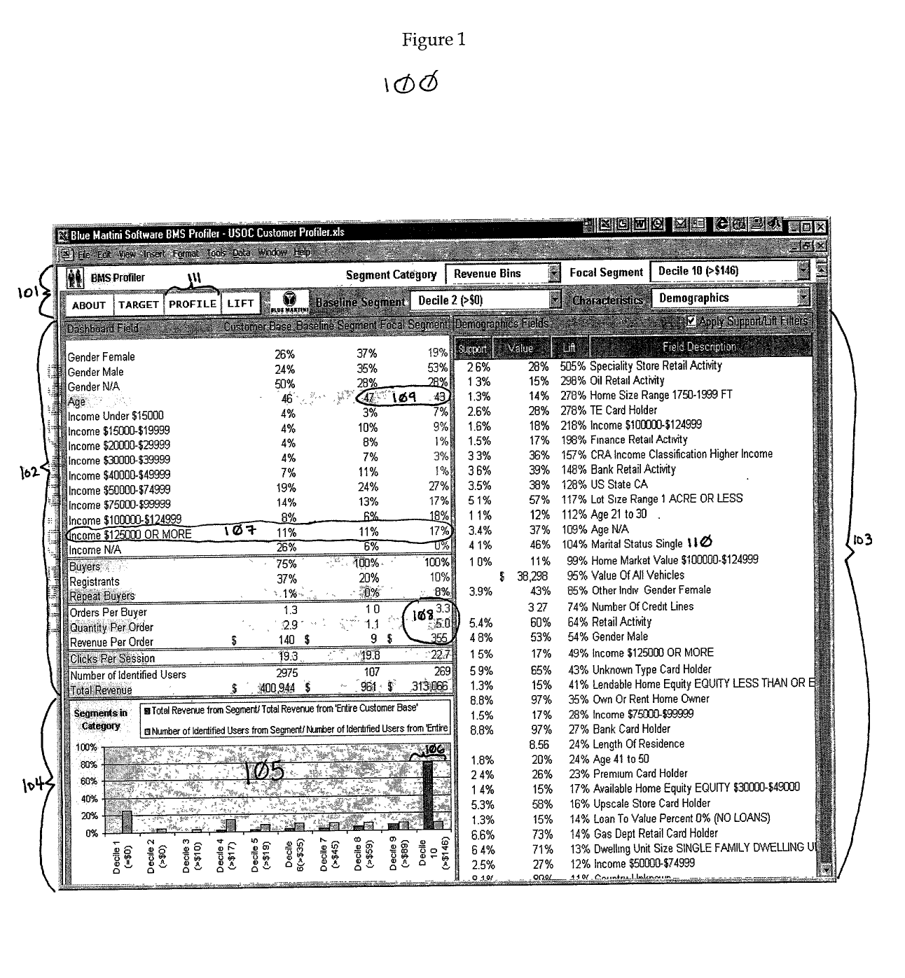

FIG. 1 shows an exemplary window of the present invention. The window may be used to visualize the Parameter Selector 101, Profile Dashboard 102, Segment Analyzer 103, and Segment Visualizer 104. The window may have entries as the ones shown in FIG. 1.

The parameter selector 101 may be located at the top of the window. It may possess drop-down menus or other software input devices known to those ordinary skilled in the art. A preferred embodiment may possess parameter menus for the Segment Category, Focal Segment, Baseline Segment, and Characteristics. The parameter selector may also contain buttons to instruct the visualizer as to which statistics the user may chose to view. A preferred embodiment may possess buttons for “Profile” or “Lift” related statistics.

The profiler dashboard 102 may be designed to allow the user to view broad aspects of customer profile data. The profiler dashboard may provide the user, for example, data regarding customer demographics, purchase data, customer relationship information, or a high-level understanding of customer data suitable for marketing decisions. Alternatively or in addition, the profiler dashboard may provide statistics regarding the data. If desired, the entries in the profiler dashboard may remain constant when the controls in the graphical user interface change.

The segment analyzer 103 may be used to enable a user to explore customer profile data in detail. The segment analyzer may be designed to allow a user to drill-down into the customer profile data to access data that the user desires to view.

The segment visualizer 104 may be used to enable a user to perform interactive graphical exploration of characteristics and other relationships across segments of customers.

The profiler operates through extensive use of a database that stores data regarding the profiles. For example, the database may store profiles of the customers that visit a web-site. Construction of the database may be performed by any known database method. Many such methods are well known in the art. A preferred embodiment of the database constructs a table with a list of entries corresponding to each customer.

The profile data may then be stored for each customer, or member, of the list. This profile data may include such items as the customer's home equity, the customer's favorite color, an indication as to whether the customer is repeat buyer, or any other possible characteristic of an entity. The database may contain several types of fields. The preferred embodiment contains fields of various data types, including: Boolean (True/False), revenue (floating point/integer), character and other numeric and text fields. In the following example demonstrating a method of storing profile data, a “person” is used as an exemplary entity. The invention extends to any other type of entity.

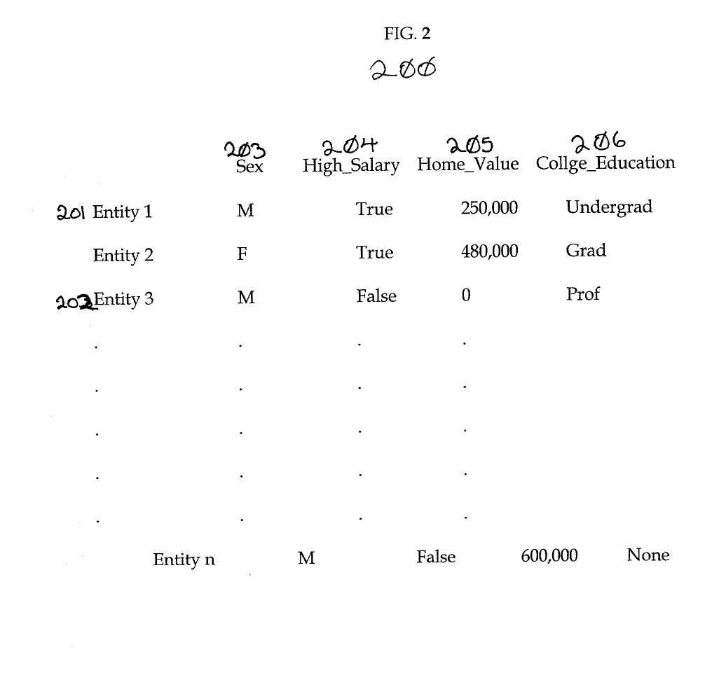

The example of a profile data table is found in FIG. 2. The example shows each entity's individual profile represented by a row of data. Each column within a given row contains profile data concerning the entity of that row. For instance, “Entity 1” 201 is a male with a high salary, a home value of $250,000, and an undergraduate college education. Similarly, “Entity 3” 202 is a male who does not have a high salary, who does not have a home, and who has a professional college education. The example also demonstrates different varieties of fields. For instance, “Sex” 203 is a character field. This field can be changed to a Boolean field by renaming the column “male” and using “true” to indicate a male entry and “false” to indicate a female entry. Furthermore, “High_salary” 204 is a field with Boolean entries. For instance, “true” may imply a salary of $50,000 or over, while a “false” may indicate a salary under $50,000. Conversely, “home_value” 205 is an example of a field with numeric entries. These numeric entries correspond to the value of the entity's home. Finally, “college_education” 206 is an example of a text field. The text field may be altered to a numeric field if necessary by assigning each possible entry a number. For instance one such scheme could be to represent, none as a 0, undergraduate as a 1, and graduate as a 2.

With entity profile database information, the user may be able to quickly implement several functions that may, with the aid of visualization, allow him to efficiently analyze the entity profile data. The computer may also automatically perform these functions and automatically display the results. In addition, the computer may also automatically display the most interesting results for the user. Such functions may be important to the user because they provide the user with vital and pertinent information regarding customer profiles. Specifically for web-site management, the information will allow the analyst to alter a web-site to enhance web-site's performance for specific individual(s) based on the individual's or a group of individuals' profiles. For instance the profile(s) may suggest that some individual(s) are more likely to by gold coins in the month of September. The web-site may then automatically generate and display for the individual(s), during the month of September, a web-page link to or a web-page of gold-coins for sale. The web-site may then automatically or the analyst may then manually then take further steps to create web-pages that match individual(s) preferences based on the individual's or individuals' profiles. The analyst or computer may display different web-pages for different user based on results of functions that may be generated by the present invention. Among the functions calculated by the present invention are the Value Ratio, Focal Values, Impact, Revenue Difference, Support, and Baseline Value. Other functions may include providing information regarding the Focal Segment, or calculating the effects of attributes of various segments of the entities. These functions are discussed in greater detail below.

The Focal Segment may be any group about which, for example the user or analyst may be interested in determining the characteristics. The Focal Segment is the current group about which a user or analyst may desire to determine the characteristics. Examples of a Focal Segment could include customers that buy black clothes, customers that are married, or customers with high home equities.

The Focal Value is the value of the Focal Segment and is calculated as follows. For Boolean fields, the Focal Value is the percentage of members of the Focal Segment that satisfy the Field Description. For the numeric fields, the Focal Value is calculated by determining the average value of the Field Description for the specified Focal Segment members. By knowing the Focal Value, an analyst is able to determine the worth of the particular segment to his or her business. A high Focal Value may mean that the particular segment is valuable to the analyst's business and is “positively-enriched.” For example, a Focal Value of 95% for a Boolean field such as “Married” means that the Focal Segment contains 95% married people. A low Focal Value could mean that the segment contains a “negative-enrichment” in the Focal Segment.

The present invention may also calculate the Value Ratio of the Focal Segment. The present invention may determine the Value Ratio by calculating the ratio of the Field Value for the Focal Segment to the Field Value for the Baseline Segment. By knowing the Value Ratio, the analyst is able to determine the relative worth of different segments of the customer base.

The present invention may further calculate the Revenue Difference for the Focal Segment. The Revenue Difference for a Boolean field is calculated by determining the difference between what a typical entity within the Field spends within the Focal Segment and what the typical entity spends within the Focal Segment. For a revenue or numeric field, the Revenue difference is determined by calculating the average revenue spent on the Field by the Focal Segment members minus the revenue spent on the Field by the Baseline Segment Members. The Revenue Difference calculation allows the analyst to quickly determine how much more or less is spent by a person in the Focal Segment than is spent by the baseline population. Higher Revenue Differences may indicate a greater disparity in spending between the compared groups.

The present invention may also calculate the Impact of a Focal Segment. For a Boolean field, the Impact is calculated by determining the Revenue Difference per person between the Focal Segment and the Baseline Segment and multiplying it by the number of Field members in the entire customer base. This number is then divided by the total revenue for all of the customers. The Impact is the percentage of all revenue that is attributable to the relationship between the Field and the Focal Segment. Thus, a large Impact demonstrates to the analyst that the cluster or group possesses a large effect on the revenue stream of the company.

The present invention may calculate the Support for the Focal Segment. For Boolean fields, the Support is calculated by determining the percentage of the entire customer base that is both in the Focal Segment and has a Field Descriptor of a particular value. The Support calculation allows the analyst to quickly determine the relative size of the Focal Segment. A higher Support may indicate that the particular value for the Field Descriptor is prevalent in the database and is therefore more statistically significant.

The present invention may further calculate the Baseline Value of the Focal Segment. The Baseline Value of the Focal Segment for a Boolean field may be determined by calculating the percentage of members of the Baseline Segment which possess a Field Descriptor of a particular value. For the revenue or other numeric fields, the Baseline Value is the average value of the Field Descriptor for the Baseline Segment members. The Baseline Value determination allows the analyst to quickly determine the value of the Focal Segment. However, other definitions for the baseline valuations may also be employed. For instance, for revenue or other numeric fields, the Baseline Value could be any function of the population contained in the Focal Segment, such as its variance, minimum, or maximum.

The present invention also allows for the Baseline Segment to be altered. In this way, different clusters may rapidly be compared to one another by changing the Baseline Segment from the entire Customer Base to a particular segment of the Customer Base. The present invention also allows the Focal Segment to be altered. In this way, different clusters may be rapidly compared to the current Baseline Segment.

In addition, the present invention also permits an analyst or software to automatically create entity clusters. The invention may use the K-means algorithm to automatically create clusters, but can use other clustering methods such as with hierarchical or neural network clustering to automatically create clusters. These automatically-created clusters further provide the analyst additional clusters of customers to explore. The automated clustering provides the advantage of allowing the analyst to quickly determine strategies or relationships that might not have been obvious to the analyst using standard groupings as clusters. For instance in the marketing arena, the analyst may be able to determine the difference between the automatically-generated clusters and the customer base by using the generated statistics to compare the created cluster against the customer base. Then, the analyst may be able to target a marketing campaign to the automatically-discovered cluster when the analyst becomes aware of the automatically-discovered cluster's attributes. In fields besides marketing, automatic clustering may also be useful in a similar manner and may provide similar benefits.

The present inventions may operate as follows. The user may view a set of profile entity data with the present invention's visualizer. The viewed profile entity data may be uploaded from a hard-disk or other storage medium. After uploading the entity profile data the user may operate the present invention to visualize and analyze the entity profile data.

The present invention may determine or define the characteristics available to the software of the present invention by obtaining them from the uploaded profile data. Other possible characteristics for the present invention may also be predetermined or predefined within the software program or within a separate database accessible to the software program.

The user or the software of the present invention may also define segments to which an individual entity may belong. The software of the present invention may define segments to which an individual entity may belong by, among other methods, performing a clustering algorithm on the uploaded entity profile data. The different characteristics of the individuals in the cluster may define the segment to which any given individual belongs. The user of the present invention may also define segments to which an individual entity may belong by, among other methods, selecting a set of individual characteristics and allowing the computer to determine which individuals possess those selected characteristics. The user may then define this group of individuals containing the user selected characteristics as a segment.

Once the data is uploaded, the user may select the “PROFILE” or “LIFT” button. Upon receipt of one of these commands, upon initialization of the system, or upon selection of a new segment, the present invention may determine the parameters currently selected by the user. The parameters may include the values or entries corresponding to the Segment Category, Baseline Segment, Focal Segment, and Characteristics of these segments. These parameters may be altered by changing an entry in a drop down menu or any other method typically used for menu selection by those ordinary skilled in the art.

After determining the value of the selected parameters or if one of the values of the selected parameters is altered, the present invention may then calculate several functions to determine statistics regarding the entity profile data the user is currently analyzing. The function calculations may be based upon the currently selected values of the selected parameters. Specifically, the present invention may calculate the Value Ratio, Focal Values, Impact, Revenue Difference, Support, and Baseline Value of currently viewed profile entity data based on the selected parameter values. The present invention may calculate these functions based on the parameters for each characteristic.

The present invention may then display the newly calculated data in the visualizer. In the Segment Visualizer the visualizer of the present invention may display the Support, Lift, Value, or any other statistics for each characteristic with the currently selected characteristic. Among other possible ordering for the listings, the listing may be by “LIFT” value from greatest to least or by “SUPPORT” value from greatest to least. The Segment Visualizer may also present only those characteristics with the highest and lowest Lifts as these may be the most interesting data to the user. For instance, in the Segment Visualizer of FIG. 1 the characteristics are presented in descending order by “LIFT” value. People of ordinary skill in the art of profiling and clustering would know what other data displays analysts would find interesting.

The Profile Dashboard screen presents other data calculated by the present invention. The present invention may statically choose the characteristics in the Profile Dashboard. A possible selection of these characteristics is seen in 102. The profiler then presents statistics on these characteristics for members of those groups that are in the Customer Base, Baseline Segment, and Focal Segment. Other selections of data to be displayed are possible in other embodiments of the invention.

The Segment Visualizer screen may create a bar graph to visualize the various groups within the Segment Category. The graph may break the Segment Category into its component segments. It may then creates a pair of bars on the bar graph for each component segment. The first bar of the pair of bars may correspond to the current Segment Category and the second bar of the pair may correspond to the specific Characteristic. The bar graphs may show what percentages of the two groups being viewed are in the current category. Other possible graphical displays such as pie charts may also be created in the Segment Visualizer.

The following series of screen shots demonstrates how a user of the invention may take advantage of its features. The screen shots show how a user may navigate screens of information to target the particular information in which the user may be interested. The series of steps demonstrates the ease with which entity profile data is analyzed using the present invention.

FIG. 1 is also an example of an opening window of data of the present invention that may be displayed to a user. When viewing this window, the user may study any of the groupings of entities presented to him. For instance, the user may become interested in studying sub-groups of entities (customers) based on their marital status. The user may want to focus on this group because the visualizer has provided him data demonstrating that people with a “marital status single” possess a support of 4.1%, a value of 46%, and a lift of 104% 104. This data indicates that this group would be an interesting group about which to obtain more data, since the members of this group tend to purchase larger quantities of goods. A Support of 4.1% indicates that 4.1% of customers are “marital status single” and are members of the Focal Segment, which in this case is membership in Revenue Decile 10. A Value of 46% indicates that 46% of the entire population is “marital status single.” Further, a Lift of 104% demonstrates that the number of people in the Focal Segment (Revenue Decile 10) is 104% larger than the number of people in the Baseline Segment (Revenue Decile 2).

While viewing a screen such as that shown in FIG. 1, the user may also notice other characteristics of purchasers from the web-site. First, the user may view that the current Focal Segment is 53% male, whereas the Baseline Segment is only 18% male. This allows the user to determine that males are more apt to buy at this site and may also be useful to target in a marketing campaign or to study in more detail. Further, the user may notice by viewing the graph in the Segment Visualizer 105 of FIG. 1 that only 10% of the heavy spenders are registered with the web-site. The analyst may determine that 10% of the heavy spenders are registered with the web-site by viewing the bars corresponding to Decile 10 in the bar graph of 106. In particular, the lighter bar of the Decile 10 corresponding to the “Number of Identified Users . . . ” represents that 10% of the heavy spenders are registered users. This knowledge may allow the user to gauge the effectiveness of his data analysis, since non-registered buyers may not have supplied profile information to the entity profile database. To view the data concerning heavy spenders, the user would change the Characteristic in the upper right hand corner of FIG. 1 (selected in FIG. 1 as “Demographics”) to a Characteristic such as “Spending”.

The user may also notice that the current Focal Segment is heavy in customers having incomes of $125,000 or more (17% as compared to 11%) 107, which could lead the user to study high income customers. Further, the analyst may notice that high income customers also have 3.3 times more orders than and buy 5 times as much as the average person in the Baseline Segment 108. The user may also notice that these higher income people tend to be younger than the average population (43 as compared to 47) 109.

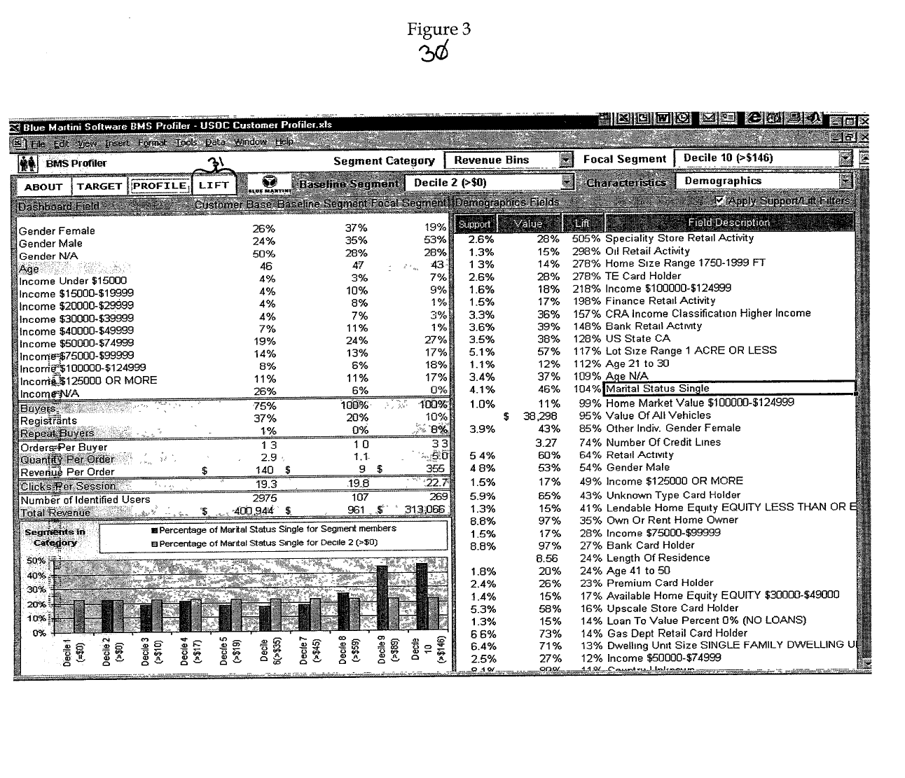

The user at this point could look more deeply at any of the above or other groups and study them in more detail. However, for this example the user will select to study the effect of marital status on purchases. To more rigorously study the effect of marital status on purchasing the user would highlight “marital status single” 110 in the segment analyzer and then press the “profile” button 111 shown in the upper left hand corner of the window shown in FIG. 1. The user may then see a window such as that shown in FIG. 3.

While viewing FIG. 3, the user may then look at the effects of marital status on lift by clicking on the “LIFT” button 31 shown in the upper left hand corner of the window shown in FIG. 3. The user may be interested in looking at lift because lift may be a primary demonstrator of groups of entities a user may want to target since they buy relatively more than ordinary customers. The “LIFT” button further allows the user to quickly identify the important salient characteristics of a segment.

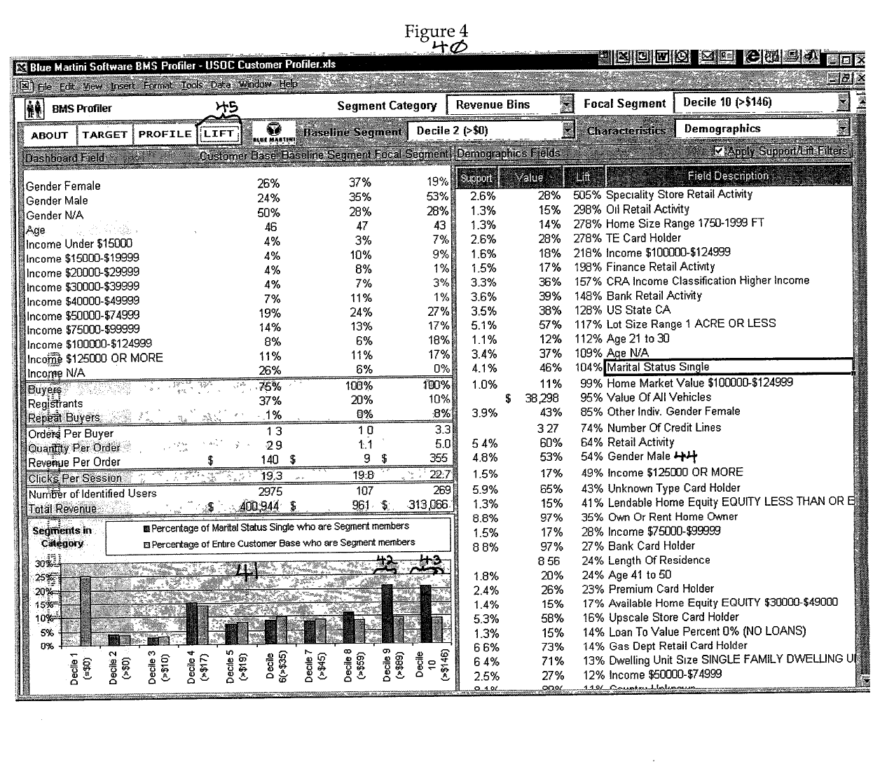

After depressing the “LIFT” button the user may be taken to a figure such as that shown in FIG. 4. In this particular case, depressing the “LIFT” button alters the Segment Visualizer 41. The Segment Visualizer now displays a graph showing the lift of the entire customer base as well as those customers who are single. This graph is broken apart by Decile into groupings based on the amount spent at the web site. Looking at the Segment Visualizer, the user may notice that single people spend more, since the bars for single people in Deciles 9 42 and 10 43 are higher than the corresponding bars in the graph for the entire customer base. The graph also indicates that there are no single people in Decile 1.

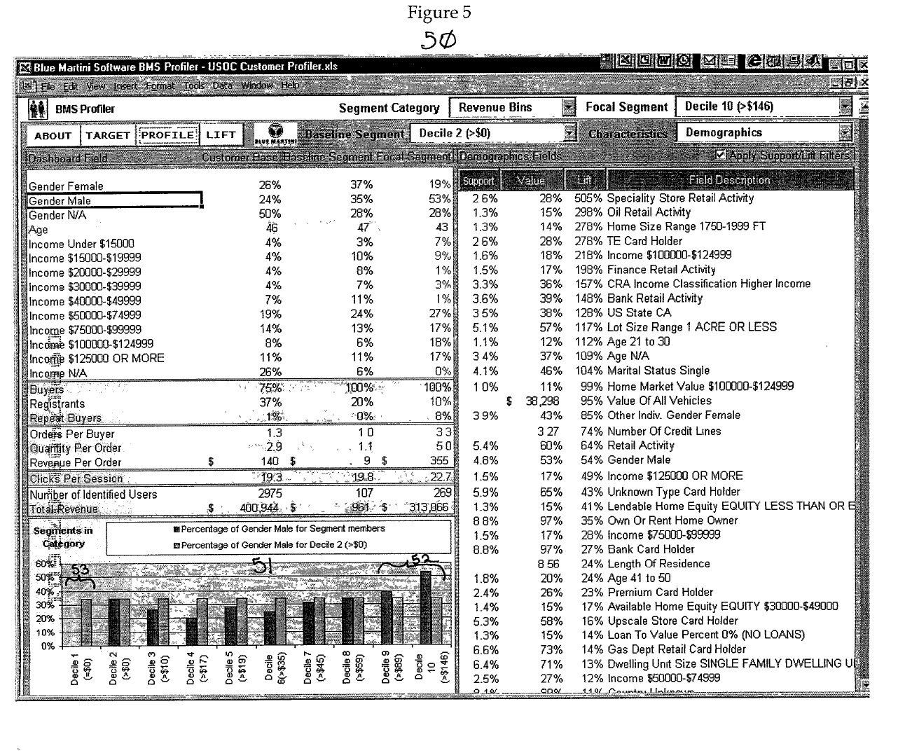

The user, as stated earlier, then may be interested in the male population so he may choose to study this population in more depth. To study the male population, the user would highlight “Gender Male” 44 in the Segment Analyzer and press the “LIFT” button 45. These actions may cause the user to be brought to a page similar to that shown in FIG. 5. From this window, the user may determine that men are more likely to be heavy spenders than women, since the bar graph in the Segment Visualizer 51 shows that more men are in the highest purchaser order categories (Deciles 9 and 10) 52 than the Baseline Segment. The graph also indicates that there are no males in the first Decile 53. The graph indicates that men shop more than women and that maleness is a characteristic of a profile of a large spender at the web-site. For instance, this knowledge can be taken into account by the web-site maintainer by creating a special web-page for male shoppers.

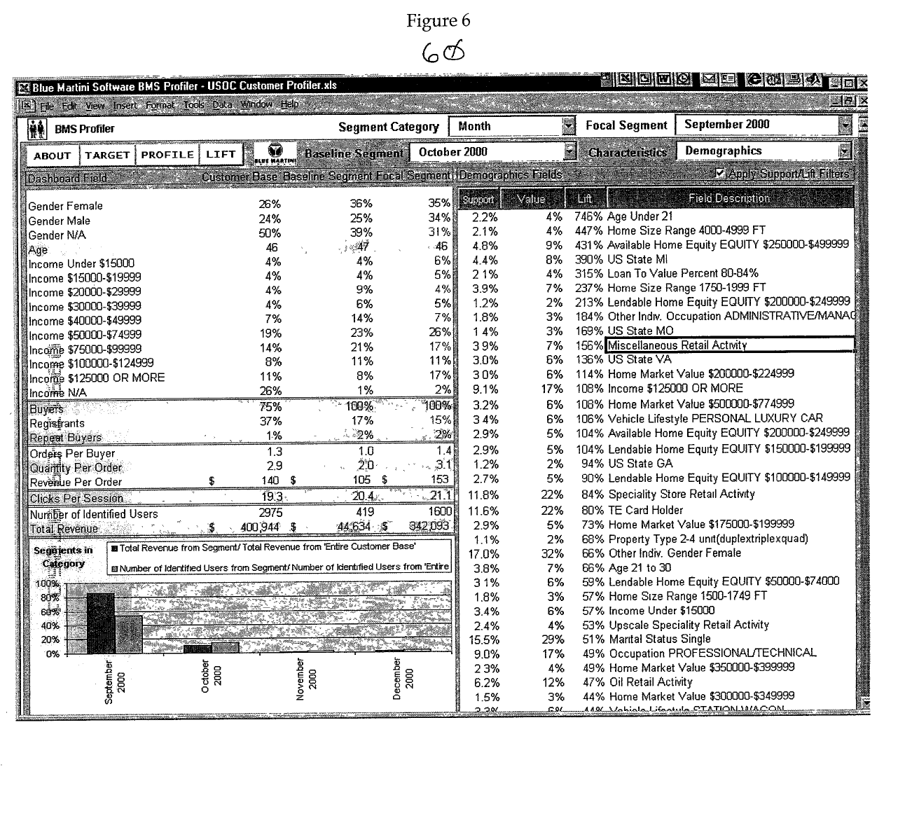

After viewing a screen such as that shown in FIG. 5, the analyst may then be interested in the effect of the month of purchases on the total amount purchased. To determine this effect, the user may change the Segment Category to “month”, the Focal Segment to “September 2000”, and the Baseline Segment to “October 2000”. Performing these actions may bring the user to a screen such as that shown in FIG. 6.

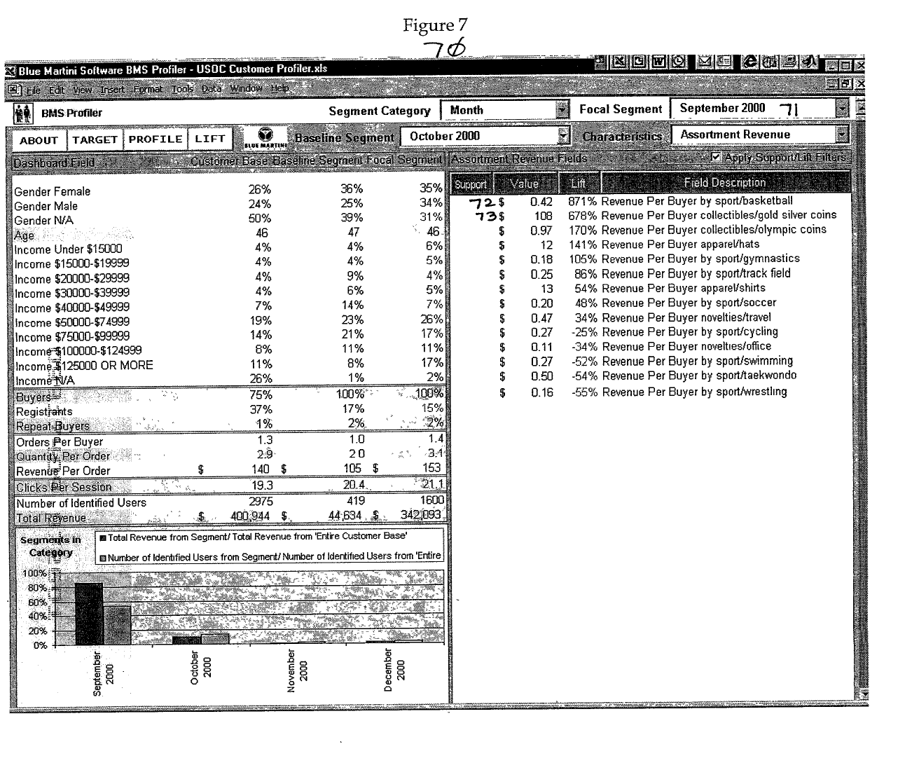

While viewing a screen such as that shown in FIG. 6, the user may note, among other interesting data, that people under the age of 21 possessed the highest lift among people who bought goods in September 2000. This may lead an analyst to target this group for even more sales. The analyst could also target other groups with high lifts or even target those with low lifts by sending them discount coupons or creating specifically tailored web-pages for them. The user after viewing this data may also be interested in what items were bought by those making purchases in September 2000. To accomplish this, the user may change the characteristic to “Assortment Revenue”. “Assortment Revenue” is a characteristic that describes the amount of revenue associated with the purchases in the assortment. By performing this action the user may be brought to a screen such as that shown in FIG. 7.

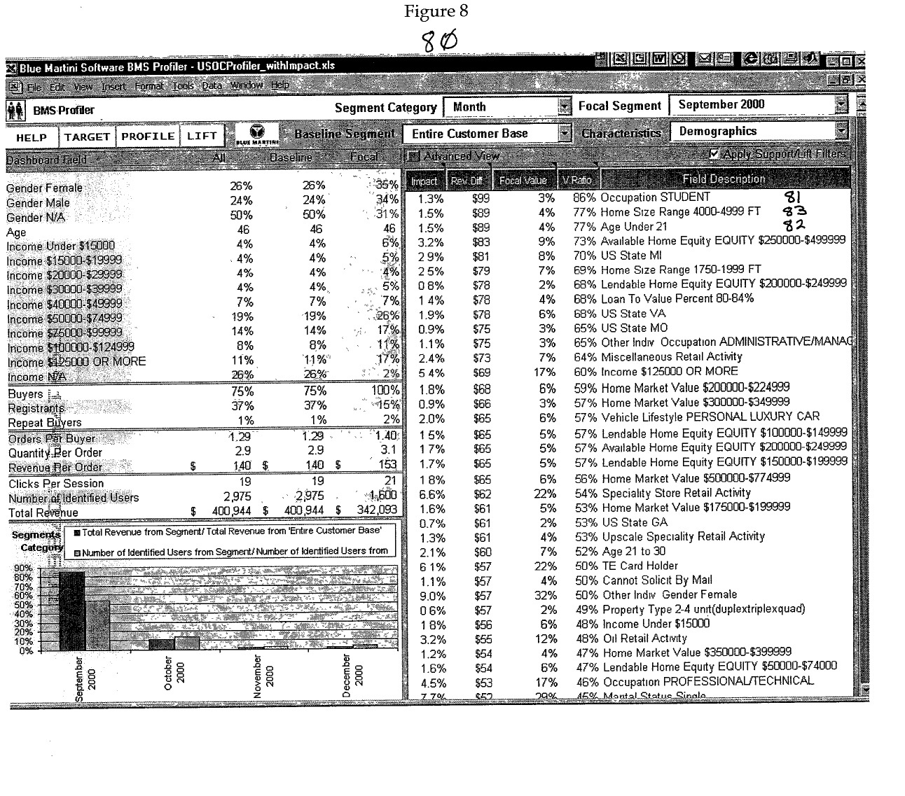

While viewing a screen such as that shown in FIG. 7, the user may notice the different items purchased by people in September 71. In particular, the user may notice that basketballs 72 and coins 73 were particularly good sellers in September. The analyst may then come to understand that people may buy basketballs and coins in September more than in most other months and could stock more of these items in those months. When faced with data, such as that shown in FIG. 7 the analyst may want to know the characteristics of the people who made purchases in September. The analyst may then view these characteristics by changing the Baseline Segment to the entire customer base. When the analyst performs this action he may be taken to a screen such as that shown in FIG. 8.

While viewing a screen, such as that shown in FIG. 8, the user may notice that the profile of the people who bought goods in September on the web-site were typically students 81 who were under twenty-one 82 and lived in large homes 83. This could suggest to the user to target younger people for media or marketing campaigns. For instance, the students could be offered a complimentary coupon or another form of promotion via electronic mail or direct mail. The analyst may also notice that the demographics indicate that a mass marketing effort in a young person's magazine would be beneficial based on the Profiler's Dashboard. Further, from viewing Segment Visualizer the user may realize that people who buy in September are less likely to purchase again in a different month relative to the entire customer base.

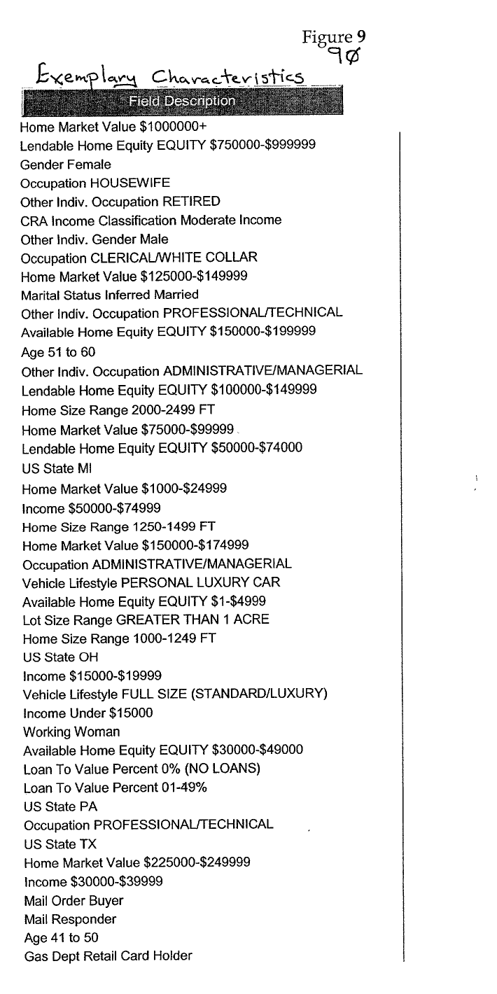

Many possible exemplary characteristics are contained in FIG. 9. These fields are used to determine the characteristics upon which the clusters of entities are based. This list of characteristics is not intended to be a closed list and may be augmented to or subtracted from as the user sees fit for the user's purposes.

The profiler may also be implemented for use in fields other than web-site profiling. Any industry in which there is a need to determine if two items are the same or different would benefit from the profiler's capability. Further any industry that needed to determine the characteristics or reasons for differences between group of entities would benefit from the invention. The profiler may help analysts in the given field determine important characteristics of why an application is effective or otherwise working properly. The profiler may also help the user understand the causes of failures in the user's system. Some examples of other fields that would benefit from the present invention include manufacturing systems, process systems, trail systems, biomedical systems, information technology systems and telecommunication systems.

The profiler may also help improve manufacturing systems and diagnose problems and failures within these systems. For instance, an automobile manufacturer may possess two factories, one in Tennessee and one in Mexico. The profiler may allow the user to determine the characteristic differences between the two, especially if one plant is constructing more cars that pass inspection. It would be difficult for an analyst to determine the cause of the difference in quality between the two plants because there could be thousands of measurements of every car made in each plant. These measurements could include weight, error tolerances, and temperature during construction. When these characteristics are inputted into the profiler, the characteristics with the highest lift are likely to be the source of the problems in the manufacturing process. Further the profiler may allow the analyst to navigate the data to help determine the important characteristics contributing to any problem or success.

The profiler also possesses the ability to improve process systems. In a process system, several processes are undertaken. These processes may all contain a degree of success and a degree of failure. The characteristics of each process and the result of the process may be entered into an entity profile database compatible with the profiler of the present invention. The characteristics of a process may include time, temperature, or number of steps.

The present invention may then calculate statistics in a visualization that may help an analyst determine what characteristics of the process are important in helping an individual process succeed or fail. The analyst may then further use the present invention to manipulate the data and statistics to more deeply understand the causes of success or failure. For instance, those characteristics with a high lift are more likely to be a cause of success or failure. Again, the profiler may allow the analyst to navigate the data to help determine the important characteristics contributing to any problem or success.

The present invention may also be beneficial for trial systems. In a trial system there are trials with several characteristics. These trials also yield results that may be successes, failures, or some combination of the two. As with process systems, an analyst may use the present invention to determine the important characteristics of the data that may cause the successes or failures in the trials.

The present invention may also be useful for profiling biomedical systems which comprise pharmaceuticals and medical devices. For instance, the present invention may be useful in determining the reasons a new anti-depressant drug that is administer to males and females works better in one group than the other group. The profiler may be inputted with patient data such as height, weight, blood pressure, or blood type. The profiler may then calculate statistics and present them in a visualizer so that an analyst may interpret them and navigate the visualizer to obtain the most relevant statistics. For instance, if it appeared sex was a determinative factor in the efficacy of the drug, the profiler may allow the analyst an opportunity to determine the causes of the drug's differing benefits to different sexes. For instance the characteristic with the highest lift would show the characteristic that may likely be linked to the results of the individual responses to the drugs.

The present invention may also be useful for information technology systems. For instance, the present invention may be used to determine why some servers crash while other do not. This would be done in a manner similar to interpreting manufacturing system profile data. The characteristics of the servers which crash and do not crash would be inputted into the present invention. Then the present invention will create statistics and a visualization that may enable the analyst to determine the characteristics that are important in the server crashes.

Similarly, the present invention may be used in the telecommunications systems field. For instance, the profiler may be used to compare callers who use local long distance to callers that use interstate long distance. Once the characteristics of the two groups are inserted into the present invention, the present invention will provide the statistics and visualization allowing the analyst to determine the characteristics which may be important to determine what causes a customer to select local long distance over interstate long distance. It will be noted that the present invention may be used in other areas of the telecommunications industry such as a diagnosis tool for the characteristics of routers that are more likely to fail.

These and other elements of the profiler execute on any one of a number of computers known to those in the art, such as a Compaq® Armada 7000 Family Computer and are visualized through a computer monitor or other display device. Further a selection device, such as a mouse, may be used to aid the analyst in selecting and specifying categories to analyze. The profiler may be stored as an application program on the hard disk or any other storage medium of a computer.

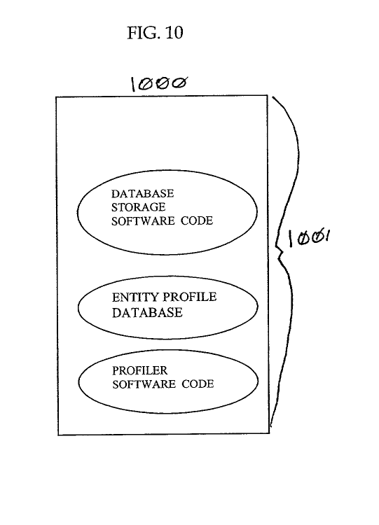

FIG. 10 shows a program storage device 1000 having a storage area 1001. Information is stored in the storage area in a well-known manner that is readable by a machine, and that tangibly embodies a program of instructions executable by the machine for performing the method of the present invention described herein for storing and interactively viewing customer profile data. Program storage device 1000 can be a magnetically recordable medium device, such as a hard drive or magnetic diskette, or an optically recordable medium device, such as an optical disk.

The embodiments describes herein are merely illustrative of the principles of this invention. Other arrangements and advantages may be devised by one skilled in the art without departing from the spirit or scope of the invention. Accordingly, the invention should be deemed not to be limited to the above detailed description, but only to the scope of the claims which follow and their equivalents.

What is claimed is:

1. A method of analyzing and presenting profile data, comprising:
(a) collecting profile data;
(b) analyzing said profile data; and
(c) visualizing said profile data.

2. The method of claim 1, wherein said profile data is obtained from web-sites.

3. The method of claim 1, wherein said profile data is obtained from manufacturing systems.

4. The method of claim 1, wherein said profile data is obtained from process systems.

5. The method of claim 1, wherein said profile data is obtained from clinical trial systems.

6. The method of claim 1, wherein said profile data is obtained from biomedical systems.

7. The method of claim 1, wherein said profile data is obtained from information technology systems.

8. The method of claim 1, wherein said profile data is obtained from telecommunications systems.

9. The method of claim 1, wherein analyzing profile data allows clustering entities according to said profile data into clusters of entities.

10. The method of claim 9, wherein said clustering is performed with K-means, hierarchical, or neural network clustering.

11. The method of claim 9, wherein said clusters are compared.

12. The method of claim 11, wherein said comparison of clusters is conducted with data comprising:
(a) customer purchases;
(b) customer viewing; and
(c) customer income.

13. The method of claim 12 wherein, said clusters are analyzed.

14. The method of claim 13, further comprising analyzing said clusters of entities to determine:
(a) the value of said cluster of entities;
(b) the number of entities in said cluster of entities; and
(c) the attributes of entities in said cluster of entities.

15. The method of claim 14, wherein said entities are customers.

16. The method of claim 1, further comprising:
reporting alternative methods of web-site design.

17. A method of altering an electronic media content, comprising:
analyzing entity profile data; and
adjusting the electronic media presentation based upon said entity profile data.

18. The method of claim 17, wherein:
said electronic media is a web-site comprised of web-pages; and
said step of adjusting electronic media comprises adjusting web-page links to account for said entity profile data.

19. The method of claim 18, wherein said step of adjusting further comprises the step of, adjusting web-page content to account for said entity profile data.

20. The method of claim 19, wherein said step of adjusting web-page content is based upon profile data for a particular web-site visitor.

21. The method of claim 20, wherein said step of adjusting web-page links is performed throughout a web-site.

22. The method of claim 21, wherein said step of adjusting web-page links is performed for all web-site visitors subsequent to determining said web-site visitors' profiles.

23. A computer system for processing entity profile data, comprising:
(a) means for collecting profile data;
(b) means for analyzing said profile data; and
(c) means for visualizing said profile data.

24. In a computer system having a graphical interface comprising a monitor and a selection device, a method of processing and displaying profile data to a user comprising the steps of:
(a) uploading profile data;
(b) analyzing said profile data;
(c) visualizing said profile data to the user on the monitor; and
(d) providing the user with menu options for the selection of alternate methods for analyzing and visualizing said profile data.

25. The method of claim 24, wherein said profile data is customer profile data.

26. A set of application program interfaces embodied on a computer-readable medium for execution on a computer in conjunction with an application program that presents entity profile data of interest to a user, comprising:
a first interface that receives parameters for a set of entity data attributes;
a second interface that receives an individual profile analysis type; and
a third interface that receives parameters for a first group of entity profile data and an individual profile analysis type and returns a second group of analyzed entity profile data wherein said second group of analyzed entity profile data matches said individual profile analysis type and said first group of profile data attributes.

27. A method of creating classifications, comprising:
(a) selecting a populations of entities;
(b) defining segments to which an individual entity may belong;
(c) selecting a subset of segments;
(d) defining characteristics of a population of entities;
(e) comparing said subset of segments against said population of entities; and
(f) determining important characteristics of said subset of segments based on said comparison.

28. The method of claim 27, wherein said comparison in step (e) is based on said characteristics defining a population.

29. The method of claim 27, wherein said comparison in step (e) is based on statistics generated to perform said comparison.

30. The method of claim 27, wherein step (c) comprises steps:
(c1) selecting a first subset of segments;
(c2) selecting a second subset of segments; and
wherein step (e) comprises comparing said first subset of segment with said second subset of segments.

31. The method of claim 27, wherein:
(I) defining a group of segments of step (b) comprises defining two segments;
(II) selecting a subset of segments of step (c) comprises selecting a subset with size two.

32. The method of claim 27, wherein said important characteristics of said subset are selected based on those which are best and worst relative to the comparison population.

33. The method of claim 27, wherein said important characteristics are displayed in a visualizer.

34. A graphical user interface to display entity profile data comprising:
(a) one or more windows to present a graphical representation of said profile data;
(b) one or more windows to present statistics generated from said profile data;
(c) one or more windows to provide menus for adjusting said profile data displayed; and
(d) means for changing said profile data by:
(1) altering said provided menus; and
(2) selecting data presented in said windows.
